(19) United States
(12) Patent Application Publication
(10) Pub. No.: US 2013/0258968 A1
(43) Pub. Date: Oct. 3, 2013

(54) DYNAMIC UPLINK RESOURCE ALLOCATION METHOD AND APPARATUS

(71) Applicant: SAMSUNG ELECTRONICS CO., LTD, Gyeonggi-do (KR)

(72) Inventors: Kiseob Hong, Gyeonggi-do (KR); Hyunwoo Lee, Gyeonggi-do (KR); Jaehee Cho, Seoul (KR)

(73) Assignee: Samsung Electronics Co., Ltd, Gyeonggi-do (KR)

(21) Appl. No.: 13/850,132

(22) Filed: Mar. 25, 2013

(30) Foreign Application Priority Data
Mar. 27, 2012 (KR) 10-2012-0031132

(51) Int. Cl. H04W 72/08

(52) U.S. Cl. CPC H04W 72/085
USPC 370/329

(57) ABSTRACT

An uplink resource allocation method and apparatus determine Modulation and Coding Scheme (MCS) level dynamically based on an MCS index table in a wireless communication system. The dynamic uplink resource allocation method of the present disclosure includes normalizing an uplink transmission power; selecting one of a current Modulation and Coding Scheme (MCS) index table and at least one candidate MCS index table; and determining a MCS level using the normalized transmission power and the selected MCS index table. The dynamic uplink resource allocation method and apparatus of the present disclosure is capable of determining the MCS level depending on the MCS index table selected optimally in consideration of the number of users and uplink resource utilization ratio of the base station that are varying as time goes, thereby enhancing single user throughput and sector throughput and thus service quality.

### CROSS-REFERENCE TO RELATED APPLICATION(S) AND CLAIM OF PRIORITY

The present application is related to and claims priority under 35 U.S.C. §119(a) to a Korean Patent Application No. 10-2012-0031132 filed on Mar. 27, 2012, in the Korean Intellectual Property Office, the contents of which are incorporated herein by reference.

### TECHNICAL FIELD

The present disclosure relates to a dynamic resource allocation and apparatus for use in a wireless communication system and, in particular, to a method and apparatus for determining Modulation and Coding Scheme (MCS) level dynamically based on an MCS index table in a wireless communication system.

### BACKGROUND

Researches are being conducted to provide users with various services requiring various data transmission capacities in the 4th Generation (4G) communication system. In the 4 G communication system, particularly, the studies are focused on the support of high data rate service, while guaranteeing mobility and service quality for the Broadband Wireless Access communication.

The communication system based on the Institute of Electrical and Electronics Engineers (IEEE) 802.16 standard is one of the representative 4 G communication systems. The IEEE 802.16 standard communication system adopts Orthogonal Frequency Division Multiplexing (OFDM)/Orthogonal Frequency Division Multiple Access (OFDMA).

In the wideband wireless communication system such as WiMAX, data transmission is performed in unit of frame which is divided into a downlink (DL) and uplink (UL) data transmission regions. The UL data transmission region is formed as a 2-Dimensional (2D) arrangement in time and frequency and consists of slots. Each slot is allocated to one of the Mobile Stations located in the same sector, and a set of the slots allocated to the MSs within a sector is referred to as burst.

In the aforementioned WiMAX communication system, the uplink radio resource is allocated in unit of slot to the MSs based on Modulation and Coding Scheme (MCS).

### SUMMARY

To address the above-discussed deficiencies of the prior art, it is a primary object to provide a method and apparatus for selecting an uplink MCS index table dynamically in consideration of the number of users and uplink resource utilization amount.

In accordance with an aspect of the present disclosure, a dynamic uplink resource allocation method includes normalizing an uplink transmission power; selecting one of a current Modulation and Coding Scheme (MCS) index table and at least one candidate MCS index table; and determining a MCS level using the normalized transmission power and the selected MCS index table.

In accordance with another aspect of the present disclosure, a dynamic uplink resource allocation apparatus includes a storage unit which stores at least one MCS index table; and a control unit which controls normalizing an uplink transmission power, selecting one of a current Modulation and Coding Scheme (MCS) index table and at least one candidate MCS index table, and determining a MCS level using the normalized transmission power and the selected MCS index table.

Before undertaking the DETAILED DESCRIPTION OF THE DISCLOSURE below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a graph for explaining an uplink MCS determination procedure based on the uplink transmission power in Frequency Reuse Pattern (FRP) 3;

FIG. 2 is a graph illustrating the principle of determining the uplink MCS index table in the dynamic uplink resource allocation method according to an embodiment of the present disclosure;

FIG. 3 is a block diagram illustrating the configuration of a dynamic UL resource allocation apparatus according to an embodiment of the present disclosure;

FIG. 4 is a flowchart illustrating the MCS level determination procedure of the UL resource allocation method according to an embodiment of the present disclosure;

FIG. 5 is a diagram illustrating a set of MCS table indices for use in the UL resource allocation method according to an embodiment of the present disclosure;

FIG. 6 is a flowchart illustrating the dynamic UL resource allocation method according to an embodiment of the present disclosure; and

FIGS. 7a and 7b are a flowchart illustrating the dynamic UL resource allocation method according to another embodiment of the present disclosure.

### DETAILED DESCRIPTION

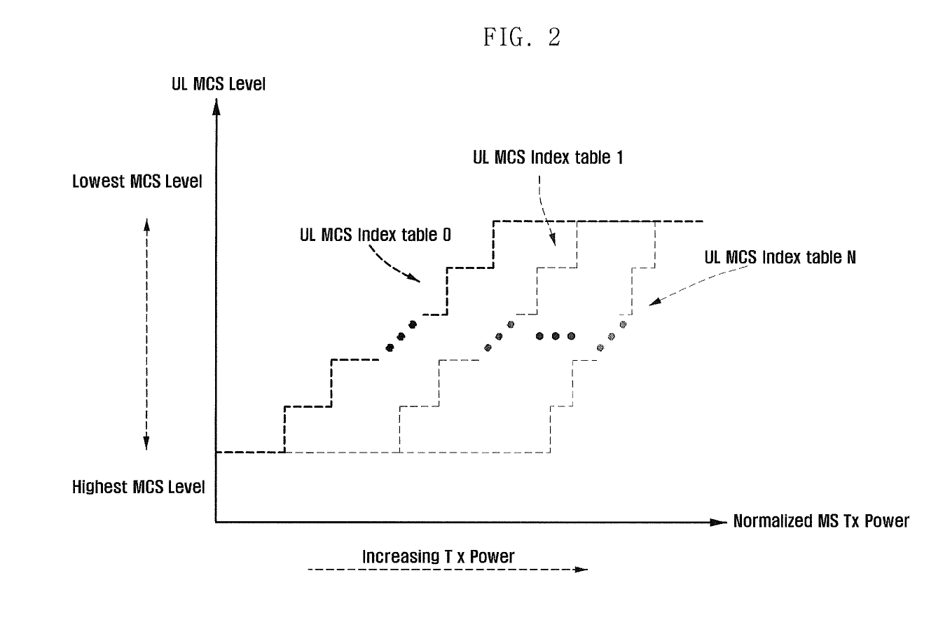

FIGS. 2 through 7b, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless technologies. Exemplary embodiments of the present disclosure are described with reference to the accompanying drawings in detail. The same reference numbers are used throughout the drawings to refer to the same or like parts. Detailed description of well-known functions and structures incorporated herein may be omitted to avoid obscuring the subject matter of the present disclosure.

In the aforementioned WiMAX communication system, the uplink radio resource is allocated in unit of slot to the MSs based on Modulation and Coding Scheme (MCS).

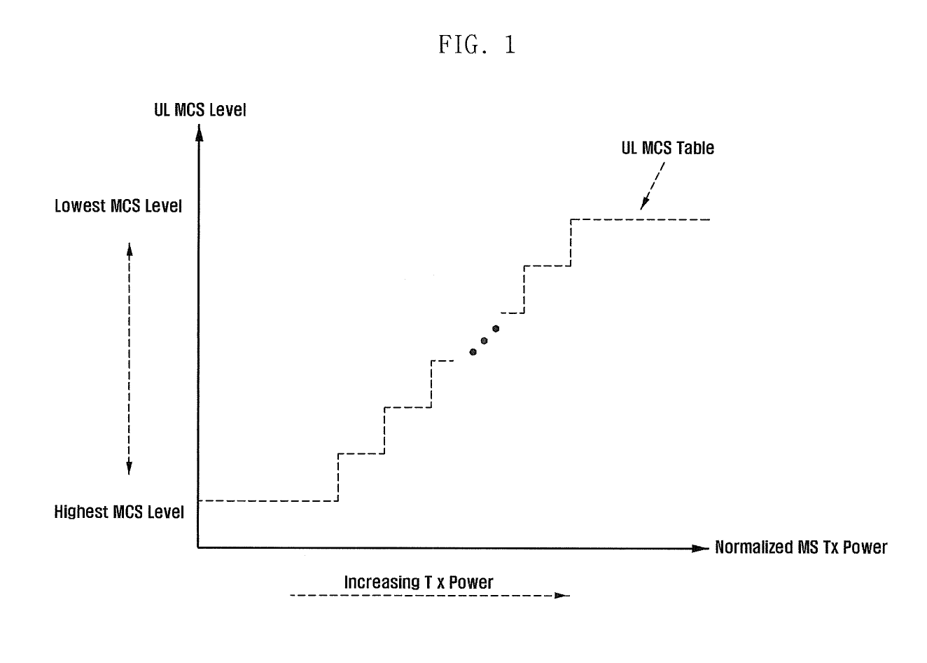

A description is made of a MCS determination procedure hereinafter with reference to FIG. 1.

FIG. 1 is a graph for explaining an uplink MCS determination procedure based on the uplink transmission power in Frequency Reuse Pattern (FRP) 3. The base station first normalizes the uplink transmission powers of all Mobile Stations (MS) into the uplink transmission power for the case where all MSs use the same uplink MCS and radio resource. Afterward, the base station compares the normalized uplink transmission power with a predetermined MCS threshold.

In FIG. 1, the UL MCS table denotes a set of thresholds necessary for converting the normalized UL transmission power to an MCS level. The UL MCS level is determined at the crossing point with the UL transmission power in UL MCS table. However, since only one set of MCS thresholds, i.e. one UL MCS table, is used for determining the MCS level, it is difficult to adjust the uplink spectral efficiency in adaptation to the uplink condition. Since the MCS threshold value is fixed and limited to the UE transmission power, it is also difficult to increases the signal user throughput and the sector throughput simultaneously. That is, if an MCS threshold which guides aggressive MCS level determination is used, this is likely to decrease both the single user throughput and sector throughput in the situation of small number of users and low UL resource utilization. In contrast, if an MCS threshold which leads to the conservative MCS level determination, this is likely to decrease the sector throughput despite of the increase of the signal user throughput in the situation of large number of users and high UL resource utilization.

FIG. 2 is a graph illustrating the principle of determining the uplink MCS index table in the dynamic uplink resource allocation method according to an embodiment of the present disclosure.

FIG. 2 shows how to determine the UL MCS level using the MCS threshold according to the MCS index table. The base station first normalizes the transmission power of a Mobile Station (MS) to the UL transmission power in the case that all MSs use and same radio resource at the same UL MCS level.

Unlike the technique operating with a single MCS index table, the dynamic UL resource allocation method according to an embodiment of the present disclosure operates with plural MCS table indices. Accordingly, it is possible to select one of uplink MCS table indices in consideration of the number of users and UL resource utilization amount. The MCS index table selection method is described in detail hereinafter.

Here, the MCS index tables are assigned unique MCS index table numbers and if N MCS index table exists, this means that N MCS index table numbers exist. The MCS index table number is allocated in an order of MCS index table guiding selection of the most conservative MCS level to the MCS index table guiding selection of the most aggressive MCS level or in reverse order. In the present disclosure, the more conservative MCS level-oriented the MCS index table is, the less the MCS index table number is; and the more aggressive MCS level-oriented the MCS index table is, the greater the MCS index table number is.

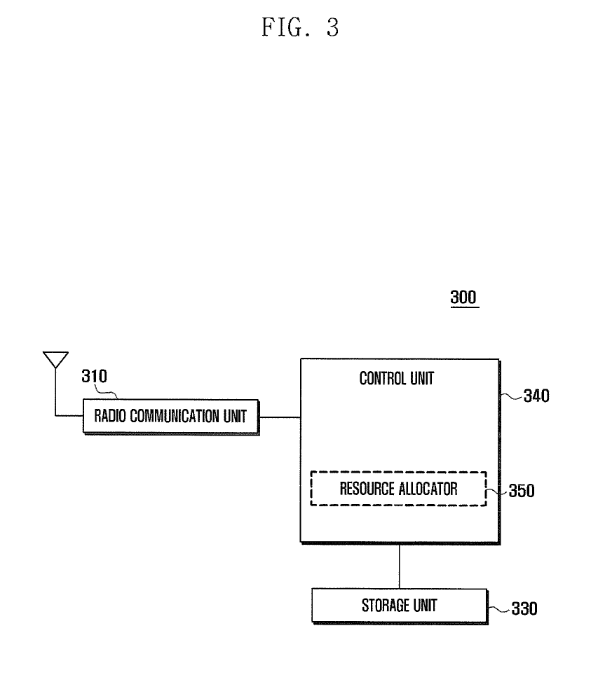

FIG. 3 is a block diagram illustrating a dynamic UL resource allocation apparatus according to an embodiment of the present disclosure. As shown in FIG. 3, the dynamic UL resource allocation apparatus 300 includes a radio communication unit 310, a storage unit 330, and a control unit 340.

The radio communication unit 310 is capable of transmitting and receiving data to and from an MS. In an embodiment of the present disclosure, the radio communication unit 310 receives UL transmission power report from the MS and sends the MS a slot allocation prediction result corresponding to the selected MCS index table as allocation information.

The storage unit 330 stores data. In an embodiment of the present disclosure, the storage unit 330 stores at least one MCS index table.

The control unit 340 normalizes the UL transmission power, selects currently MCS index table, and controls determining MCS level based on the normalized UL transmission power and the selected MCS index table. In order to achieve this, the control unit 340 includes a resource allocator 350 according to an embodiment of the present disclosure.

As described above, the base station is capable of selecting an MCS index table capable of optimizing the network throughput in consideration of the number of users and UL resource utilization amount among plural MCS table indices.

The resource allocator 350 calculates a utility metric per index table which indicates the total data amount that can be transmitted with the allocated resource based on the resource allocation amount and the data amount transmittable per unit resource in selecting the MCS index table, determines whether the current utility matric calculated using the currently used MCS index table is equal to or greater than all candidate utility metrics calculated using the respective candidate MCS index tables, and controls maintaining, when the current utility metric is equal to or greater than all candidate utility metrics, the current MCS table.

At this time, the utility metric is determined by Equation (1):

$$UtilityMetric = {\sum }_{user i} {( ScheduleSlot )}_{user i} \times ( MPR [ {MCS}_{user i} ] ) \qquad ( 1 )$$

where ScheduleSlot_{user i} denotes per-user slot allocation prediction result, and MPR[MCS_{user i}] denotes Modulation order Product Coding Rate (MPR) corresponding to the per-user MCS level.

That is, ScheduleSlot_{user i} corresponds to the resource allocation amount and MPR denotes the data amount transmittable per unit resource and, as a consequence, the utility metric is total data amount transmittable on the allocated resource according to Equation (1).

If the current utility metric is less than any of all candidate utility metrics, the resource allocator 350 controls to select the candidate MCS index table having a candidate utility metric fulfilling a predetermined condition.

The resource allocator 350 is also capable of determining the next frame candidate MCS index table to be compared with the MCS index table selected in the next frame. The resource allocator 350 determines whether the current MCS index table has changed in determining next frame candidate MCS index table and controls, if the current MCS index table has been changed, to change the candidate MCS index table according to the selected MCS index table.

At this time, if the selected MCS index table has been changed to have more conservative MCS level as compared to the current MCS index table, the resource allocator 350 changes the candidate MCS index table to have more conservative MCS level as compared to the selected MCS index table. Otherwise, if the selected MCS has been changed to have more aggressive MCS level as compared to the current MCS index table, the resource allocator 350 changes the candidate MCS index table to have more aggressive MCS level as compared to the selected MCS index table. The resource allocator 350 is also capable of controlling to maintain the current candidate MCS index table, when the current MCS index table has not been changed.

Through the above procedure, the base station is capable of selecting an optimal MCS index table dynamically by reflecting the number of users and UL resource utilization ratio that are varying as time goes. Although it is ideal to calculate the utility metrics of all MCS index tables at every frame and select the MCS index table having the greatest utility metric, it is effective to select an appropriate MCS index table among the candidate MCS index table indices and the current MCS index table by taking notice of the restricted computing power of the control unit 340.

The resource allocator 350 determines the MCS level using the selected MCS index table.

Although the description is directed to the case whether the resource allocator 350 is formed as a function block separated from the control unit 340, this configuration is only for the sake of convenience of explanation. For example, the function of the resource allocator 350 can be performed by the control unit 340.

In the following, the description is made under the assumption that the control unit 340 performs the function of the resource allocator 350.

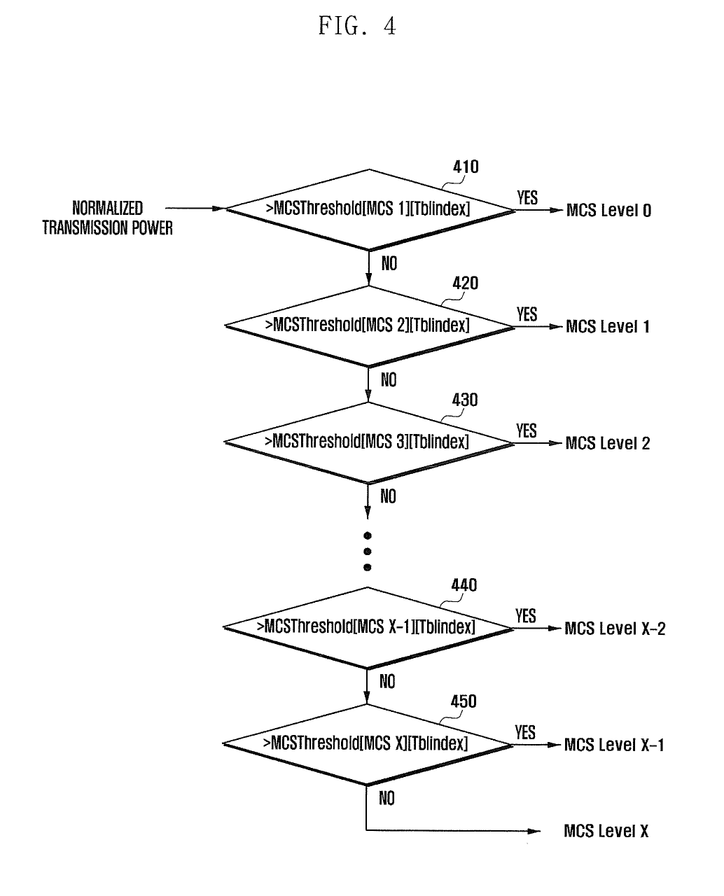

A description is made of the MCS level determination procedure in more detail with reference to FIG. 4.

FIG. 4 is a flowchart illustrating the MCS level determination procedure of the UL resource allocation method according to an embodiment of the present disclosure.

Since the MCS index table (TblIndex) is a set of UL MCS thresholds, if an MCS index table is selected, an MCS threshold set is determined automatically by the MCS index table.

First, the base station compares the normalized transmission power with the threshold value of MCS level 1 (MCSThreshold[MCS 1][TblIndex]) at step 410 and, if the normalized transmission power is greater than the MCS level 1 threshold value, sets the MCS level to MCS level 0. Otherwise, if the normalized transmission power is equal to or less than the MCS level 1 threshold value, the base station compares the normalize transmission power with the threshold value of MCS level 2 (MCSThreshold[MCS 2] [TblIndex]) at step 420 and, if the normalized transmission power is greater than the MCS level 2, sets the MCS level to MCS level 1 and, otherwise, the procedure goes to step 430. This configuration is repeated in stepwise manner such that if the normalized transmission power is equal to or less than minimum MCS level X, the MCS level is set to MCS level X.

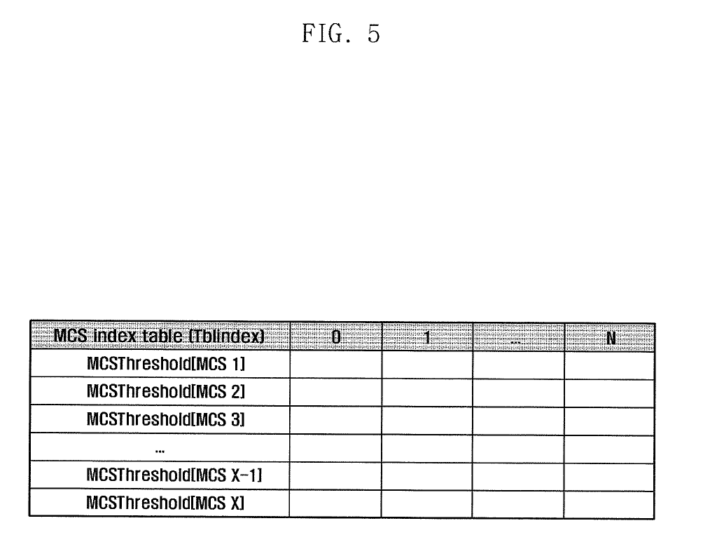

The MCS threshold set necessary for determining the MCS level as described above is the MCS index table. A set of MCS index tables is summarized in FIG. 5.

FIG. 5 is a diagram illustrating a set of MCS index tables for use in the UL resource allocation method according to an embodiment of the present disclosure.

In FIG. 5, N+1 MCS index table are listed and are assigned unique MCS index table numbers of from 0 to N respectively. As described above, the more conservative MCS level-oriented the MCS index table is; and the more aggressive MCS level-oriented the MCS index table is, the greater the MCS index table number is. Although the description is directed to the case where the MCS threshold value diminishes as the MCS level grows from [MCS 1] to [MCS X] in an embodiment of the present disclosure, the MCS level determination can be performed in the course that MCS threshold value ascends.

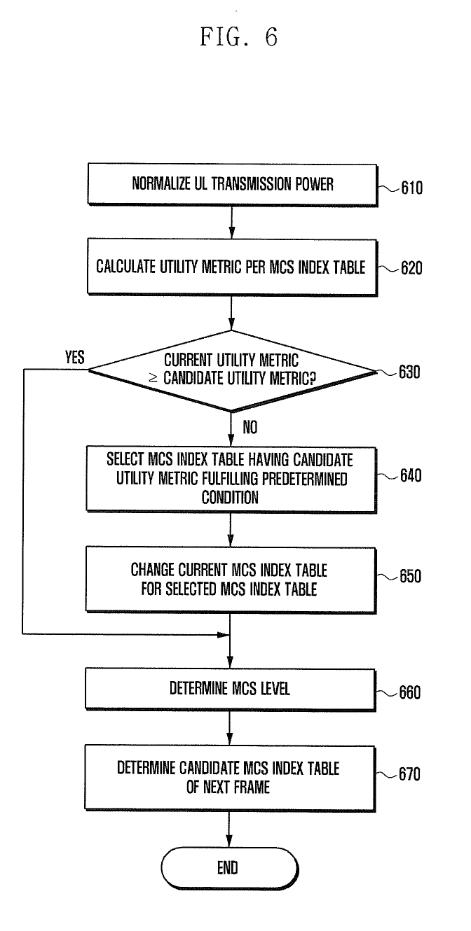

FIG. 6 is a flowchart illustrating the dynamic UL resource allocation method according to an embodiment of the present disclosure.

First, the control unit 340 normalizes the uplink transmission power at step 610. At this time, the control unit 340 normalizes the transmission power of an MS to the UL transmission power in the case that all MSs use and same radio resource at the same UL MCS level.

Afterward, the control unit 340 calculates utility metric indicating the total data amount transmittable with the allocated resource using the resource allocation amount per MCS index table and the data amount transmittable per unit resource. Since the utility metric indicates the total data amount transmittable with the allocated resource, the total transmittable data amount increases in proportion to the value of the utility metric, resulting in improvement of service quality.

At this time, the utility metric is determined by Equation (1).

That is, ScheduleSlot_{user i} corresponds to the resource allocation amount and MPR denotes the data amount transmittable per unit resource and, as a consequence, the utility metric is total data amount transmittable on the allocated resource according to Equation (1).

Next, the control unit 230 determines whether the current utility metric calculated with the currently used MCS index table is equal to or greater than all candidate utility metrics calculated with respective MCS index tables at step 630.

If the current utility metric is equal to or greater than all individual candidate utility metrics, the control unit 304 maintains the current MCS table and determines the MCS level using the UL transmission power and selected MCS table as described above at step 660. If the current utility metric is less than any of all candidate utility metrics, the control unit 340 selects the candidate MCS index table having the candidate utility metric fulfilling a predetermined condition at step 640. Next, the control unit 340 changes the current MCS index table for the selected MCS index table at step 650 and determines the MCS level using the UL transmission power and selected MCS index table as described above at step 660.

Afterward, the control unit 340 determines the candidate MCS index table of the next frame at step 670. The control unit 340 determines whether the current MCS index table has been changed in determining the next frame candidate MCS index table and, if so, changes the candidate MCS index table for the selected MCS index table at step 650.

If the selected MCS index table has been changed to have more conservative MCS level than that of the current MCS index table, the control unit 340 changes the candidate MCS index table to have the more conservative MCS level than that of the selected MCS index table. Otherwise, if the selected MCS index table is has been changed to have more aggressive MCS level than that of the current MCS index table, the control unit 340 changes the candidate MCS index table to have the more aggressive MCS level than that of the selected MCS index table.

If it is determined that the current MCS index table has not been changed in determining the next frame candidate MCS index table at step 650, the control unit 340 controls to maintain the current MCS index table.

Once the current MCS index table is determined through the above procedure, it is also possible to determine the candidate MCS index table of the next frame. In this way, the base station is capable of selecting the MCS index table dynamically in adaptation to the current situation.

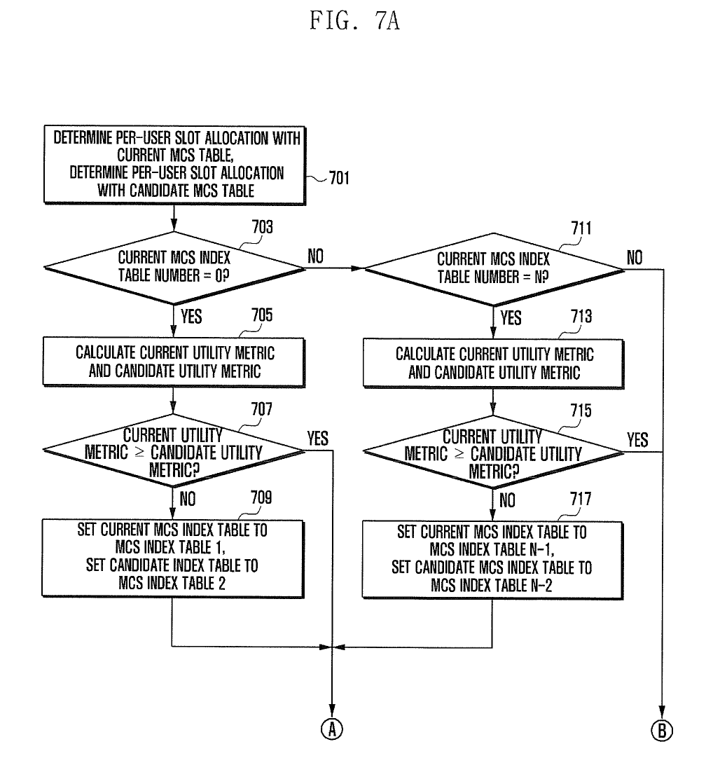

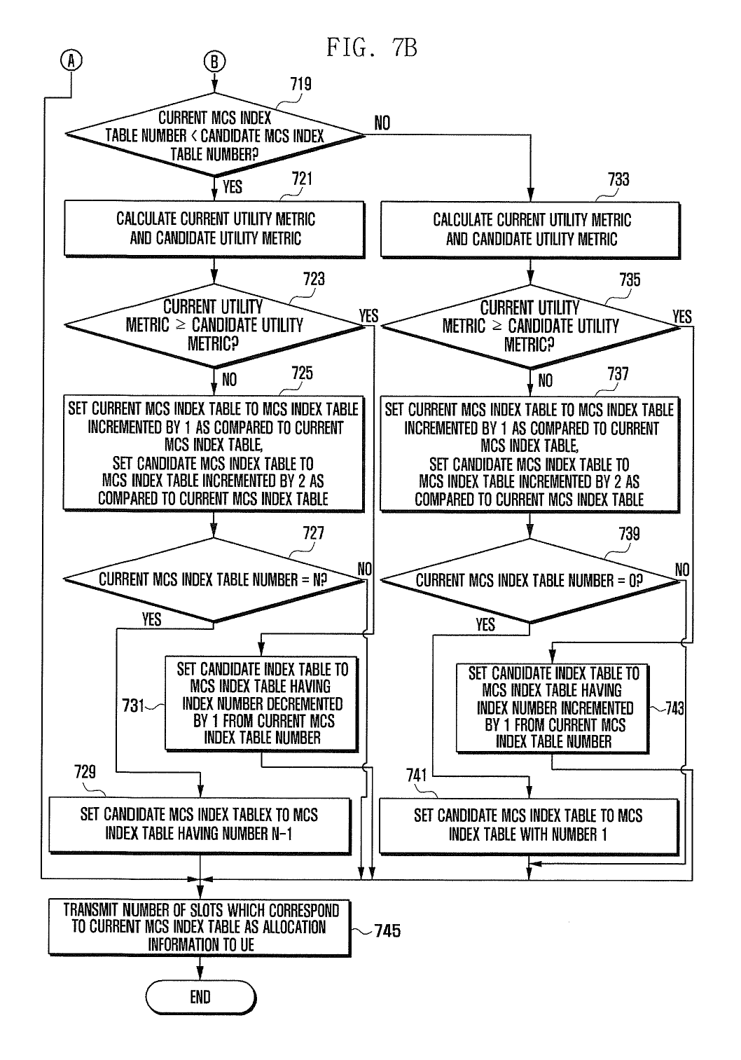

This procedure is described in more detail with reference to FIGS. 7a and 7b.

FIGS. 7a and 7b are a flowchart illustrating the dynamic UL resource allocation method according to another embodiment of the present disclosure. In FIGS. 7a and 7b, the description is made under the assumption that there is on candidate MCS index table by taking notice of the computing capability of the control unit 340. Also, it is assumed that total N+1 MCS index tables each assigned MCS index table numbers of from 0 to N.

The control unit 340 first calculates per-user MCS prediction result (MCS user i) and slot allocation prediction result (SchedulerSlot user i) using the current MCS index table at step 701. Simultaneously, the control unit 340 also calculates per-user MCS prediction result (MCS user i) and slot allocation prediction result (SchedulerSlot user i) using the candidate MCS index table and the procedure goes to step 703. Here, the MCS prediction result is the resource allocation amount for the user, and the slot allocation prediction result is the data amount transmittable per unit resource.

The control unit 340 determines whether the current index table number is 0 and, if so, the procedure goes to step 705 and, otherwise, step 711. The control unit 340 calculates current utility metric using Equation (1) based on the per-user MCS and slot allocation prediction result acquired with the current MCS index table at step 705. The control unit 340 also calculates candidate utility metric using Equation (1) based on the per-user MCS and slot allocation prediction result acquired with the candidate MCS index table.

That is, ScheduleSlot_{user i} corresponds to the resource allocation amount and MPR denotes the data amount transmittable per unit resource and, as a consequence, the utility metric is total data amount transmittable on the allocated resource according to Equation (1). If the utility metric increases, this means both the signal user through put and sector throughput increase.

The control unit 340 determines whether the current utility metric is equal to or greater than the candidate utility metric at step 707. If the current utility metric is equal to or greater than the candidate utility metric, the control unit 340 sends the MS the allocation information including the number of slots, which corresponds to the current MCS index table at step 745. Otherwise, if the current utility metric is less than the candidate utility metric, the control unit 340 changes the current MCS index table for the MCS index table 1 and the candidate MCS index table for the MCS index table 2 at step 70 and sends the MS the allocation information including the number of slots, which corresponds to the current MCS index table at step 745. At this time, since the current MCS index table is the least index table 0, the control unit 340 sets the MCS index table to the MCS index table 1 having the next index number and the candidate MCS index table to the MCS index table 2.

If the current MCS index table number is not 0 at step 703, the procedure goes to step 711. If the current index table number is N at step 711, the procedure goes to step 713 and, otherwise, step 719. The control unit 340 calculates the current utility metric and candidate utility metric at step 713 as described above and determines whether the current utility metric is equal to or greater than the candidate utility metric at step 715. If the current utility metric is equal to or greater than the candidate utility metric, the control unit 340 maintains the current MCS index table and candidate MCS index table and sends the number of slots, which corresponds to the current index table as the allocation information at step 745. Otherwise, if the current utility metric is less than the candidate utility metric, the control unit 340 changes the current MCS index table for MCS index table N−1 and the candidate MCS index table for MCS index table N−2 at step 717 and sends the MS the number of slots, which corresponds to the current MCS index table as the allocation information at step 745. At this time, since the current MCS index table is the greatest MCS index table number N, the control unit 340 changes the MCS index table for the MCS index table N−1 having the next greatest index number and the candidate MCS index table for the MCS index table N−2.

The control unit 340 determines whether the current MCS index table number is less than the candidate MCS index table number at step 719 and, if so, the procedure goes to step 721 and, otherwise, step 733.

The control unit 340 calculates the current utility metric and the candidate utility metric at step 721 as described above and determines whether the current utility metric is equal to or greater than the candidate utility metric at step 723. If the current utility metric is equal to or greater than the candidate metric, the control unit 340 decrements the candidate MCS index table number by 1 as Equation 2 at step 731 and sends the MS the number of slots, which corresponds to the current MCS index table as the allocation information at step 745.

Candidate MCS index table No.=Current MCS index table No.−1 (2)

If the current utility metric is less than the candidate utility metric at step 721, the control unit 340 sets the current MCS index table to the MCS index table having the index number incremented by 1 from the current MCS index table number as Equation (3) and the candidate MCS index table to a MCS index table having the index number incremented by 2 from the current MCS index table number as Equation (4).

Current MCS index table No.=Current MCS index table No.+1 (3)

Candidate MCS index table No.=Current MCS index table No.+2 (4)

Afterward, the control unit 340 determines whether the current MCS index table is N at step 727 and, if the current MCS index table is not N, sends the MS the number of slots which corresponds to the current MCS index table as the allocation information at step 745. If the current MCS index table is N at step 727, the control unit 340 sets the candidate MCS index table to the MCS index table having the index number N−1 at step 729 and sends the MS the number of slots which corresponding to the current MCS index table as the allocation information.

If the current MCS index table number is greater than the candidate MCS index table number at step 719, the control unit calculates the current utility metric and candidate utility metric at step 733 as described above and determines whether the current utility metric is equal to or greater than the candidate utility metric at step 735. If the current utility metric is equal to or greater than the candidate utility metric, the control unit sets the candidate MCS index table to a new MCS index table having the index number incremented by 1 at step 743 and sends the MS the number of slots which corresponds to the current MCS index table as the allocation information.

If the current utility metric is less than the candidate utility metric, the control unit 340 sets the current MCS index table to a new MCS index table having the index number increment by 1 from the current MCS index table number as Equation (6) and the candidate MCS index table to a new MCS index table having the index number increment by 2 as Equation (7) at step 737.

Current MCS index table No.=Current MCS index table No.+1 (6)

Candidate MCS index table No.=Current MCS index table No.+2 (7)

Afterward, the control unit 340 determines whether the current MCS index table is 0 at step 739 and, if the current MCS index table is not 0, sends the MS the number of slots which corresponds to the current MCS index table as allocation information at step 745. Otherwise, if the current MCS index table is 0 at step 739, the control unit sets the candidate MCS index table to a new MCS index table having the MCS index table number incremented by 1 at step 741 and sends the MS the number of slots which corresponds to the current MCS index table as allocation information at step 745.

As described above, the dynamic uplink resource allocation method and apparatus of the present disclosure is capable of determining the MCS level according to the MCS index index selected optimally in consideration of the number of users and uplink resource utilization ratio of the base station that are varying as time goes, thereby enhancing single user throughput and sector throughput and thus service quality.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A dynamic uplink resource allocation method comprising:
normalizing an uplink transmission power;
selecting one of a current Modulation and Coding Scheme (MCS) index table and at least one candidate MCS index table; and
determining a MCS level, using the normalized transmission power and the selected MCS index table.

2. The method of claim 1, wherein the selecting one comprises:
calculating a utility metric indicating total data amount transmittable with resource allocated based on a resource allocation amount per MCS index table and data amount transmittable per unit resource;
determining whether the current utility metric calculated based on the current MCS index table is equal to or greater than all of the candidate utility metrics calculated based on the respective candidate MCS table indices; and
maintaining, when the current utility metric is equal to or greater than all of the candidate utility metrics, the current MCS table.

3. The method of claim 2, further comprising:
selecting, when the current utility metric is less than any of candidate utility metrics, one of the candidate MCS index tables, which fulfills a predetermined condition.

4. The method of claim 2, wherein the utility metric is determined by an equation:
$$UtilityMetric = {\sum }_{user i} {( ScheduleSlot )}_{user i} \times ( MPR [ {MCS}_{user i} ] )$$
where ScheduleSlot_{user i} denotes per-user slot allocation prediction result, and MPR[MCS_{user i}] denotes Modulation order Product Coding Rate (MPR) corresponding to the per-user MCS level.

5. The method of claim 1, the method further comprising:
determining, after determining a MCS level, a next frame candidate MCS index table to be compared with the selected MCS index table.

6. The method of claim 5, wherein the determining of a next frame candidate MCS index table comprises:
determining, in selecting one of MCS index tables, whether the current MCS index table has been changed; and
changing, when the current MCS index table has been changed, the candidate MCS index table for a new candidate MCS index table according to the selected MCS index table.

7. The method of claim 6, wherein changing the candidate MCS index table comprises:
changing, when the selected MCS index table is changed to have an MCS level more conservative as compared to the current MCS index table, the candidate MCS index table to have more conservative MCS level as compared to the selected MCS index table; and
changing, when the selected MCS index table is changed to have an MCS level more aggressive as compared to the current MCS index table, the candidate MCS index table to have more aggressive MCS level.

8. The method of claim 6, wherein determining a next frame candidate MCS index table comprises maintaining, when the current MCS index table has not been changed, the current candidate MCS index table.

9. A dynamic uplink resource allocation apparatus comprising:
a storage unit configured to store at least one MCS index table; and
a control unit configured to control normalizing an uplink transmission power, selecting one of a current Modulation and Coding Scheme (MCS) index table and at least one candidate MCS index table, and determining a MCS level using the normalized transmission power and the selected MCS index table.

10. The apparatus of claim 9, wherein the control unit is configured to control calculating a utility metric indicating total data amount transmittable with resource allocated based on a resource allocation amount per MCS index table and data amount transmittable per unit resource, determining whether the current utility metric calculated based on the current MCS index table is equal to or greater than all of the candidate utility metrics calculated based on the respective candidate MCS index table, and maintaining, when the current utility metric is equal to or greater than all of the candidate utility metrics, the current MCS index table.

11. The apparatus of claim 10, wherein the control unit is configured to control selecting, when the current utility metric is less than any of candidate utility metrics, one of the candidate MCS index tables, which fulfills a predetermined condition.

12. The apparatus of claim 10, wherein the utility metric is determined by an equation:
$$UtilityMetric = {\sum }_{user i} {( ScheduleSlot )}_{user i} \times ( MPR [ {MCS}_{user i} ] )$$
where ScheduleSlot_{user i} enotes per-user slot allocation prediction result, and MPR[MCS_{user i}] denotes Modulation order Product Coding Rate (MPR) corresponding to the per-user MCS level.

13. The apparatus of claim 9, wherein the control unit is configured to control determining a next frame candidate MCS index table to be compared with the selected MCS index table.

14. The apparatus of claim 13, wherein the control unit is configured to control determining, in selecting one of MCS table indices, whether the current MCS index table has been changed and changing, when the current MCS index table has been changed, the candidate MCS index table for a new candidate MCS index table according to the selected MCS index table.

15. The apparatus of claim 14, wherein the control unit is configured to control changing, when the selected MCS index table is changed to have an MCS level more conservative as compared to the current MCS index table, the candidate MCS index table to have more conservative MCS level as compared to the selected MCS index table and changing, when the selected MCS index table is changed to have an MCS level more aggressive as compared to the current MCS index table, the candidate MCS index table to have more aggressive MCS level.

16. The apparatus of claim 14, wherein the control unit is configured to control maintaining, when the current MCS index table has not been changed, the current candidate MCS index table.
